(19) United States
(12) Patent Application Publication
(10) Pub. No.: US 2021/0201234 A1
(43) Pub. Date: Jul. 1, 2021

(54) INTELLIGENT REGULATION SYSTEM FOR ASSET MANAGEMENT

(71) Applicant: HEFEI HDB INFORMATION TECHNOLOGY CO., LTD., Anhui (CN)

(72) Inventors: Chen YU, Anhui (CN); Yanli KONG, Anhui (CN)

(73) Assignee: HEFEI HDB INFORMATION TECHNOLOGY CO., LTD., Anhui (CN)

(21) Appl. No.: 16/309,466

(22) PCT Filed: Oct. 31, 2018
(86) PCT No.: PCT/CN2018/112956

§ 371 Date: Dec. 13, 2018

(30) Foreign Application Priority Data
Aug. 23, 2018 (CN) 201810966541.8

(51) Int. Cl. G06Q 10/06; G06N 5/04

(52) U.S. Cl. CPC G06Q 10/06315; G06N 5/04

(57) ABSTRACT

An intelligent regulation system for asset management is provided, wherein an area regularization module is configured to divide a target space into M deposit areas and divide each deposit area is divided into N deposit sub-areas; a volume regularization module is configured to select a deposit area according to volume and weight of an asset; an information regularization module is configured to select the deposit sub-area according to a type and use of the asset; an information matching module is configured to associate the volume and weight of the asset as identification information with a numbering of the asset deposit sub-area, and associate an occupied status of M×N deposit sub-areas with the identification information; an intelligent regulation module is configured to formulate an asset management regulation strategy. The disclosure determines whether the assets have been in abnormal situations according to the actual volume and actual weight to optimize asset management.

This application claims priority to Chinese Patent Application No. 201810966541.8, filed to the Chinese Patent Office on Aug. 23, 2018, entitled intelligent regulation system for asset management, the entire disclosure of which is incorporated herein by reference.

### 1. Technical Field

The present invention relates to the technical field of asset management systems, and in particular, to an intelligent regulation system for asset management.

### 2. Background of the Invention

With the development of society, people need to manage more and more assets, especially the quantity and variety of assets that need to be managed in enterprises and families, which brings great inconvenience to people's life and work. Therefore, people use various methods to classify and manage various assets, and monitor the real-time status of various materials to avoid the loss of materials. At present, most enterprises rely on manual management of assets, such as labeling various materials, and regularly verifying and registering the use and deposit of assets. However, this method requires a lot of manpower and resources, and the work efficiency is low. Moreover, relying on management personnel to manage assets, it is inevitable that there will be omissions such as verification, registration or registration errors, which may easily lead to chaotic asset management, which is not conducive to the production management of enterprises.

### SUMMARY OF THE INVENTION

Based on the existing technical problems in the background art, the present application proposes an intelligent regulation system for asset management.

The intelligent regulation system for asset management proposed by the application includes:

an area regularization module, configured to divide a target space into M deposit areas, and respectively divide each deposit area into N deposit sub-areas;

a volume regularization module, configured to obtain the volume and weight of an asset, and select a deposit area according to the volume and weight of the asset;

an information regularization module, configured to obtain a type and use of the asset in the deposit area, and select the deposit sub-area according to the type and use of the asset;

an information matching module, configured to associate and store the volume and weight of the asset as identification information with the numbering of the asset deposit sub-area, also associate and store occupied status of the M×N deposit sub-areas with the identification information of the asset;

an intelligent regulation module, configured to formulate an asset management regulation strategy based on the occupied status of an ijth deposit sub-area, the identification information of the asset in the ijth deposit sub-area, and the actual volume and actual weight of the asset in the deposit sub-area;

where, M and N are preset values, M≥3, N≥3, 1≤i≤M, 1≤j≤N.

Preferably, in the area regularization module, the M deposit areas include x large volume areas, y large weight areas, and z balanced areas;

where x, y, and z are preset values, x+y+z=M, 1≤x<M, 1≤y<M, 1≤z<M.

Preferably, a first volume V1, a first weight W1, and z state preset values are stored in the volume regularization module, which are denoted as S₁, S₂, S₃ . . . S_{z}, where S₁<S₂<S₃< . . . <S_{z};

the volume regularization module is specifically configured to:

obtain the volume and weight of the asset, respectively denoted as V and W;

compare the volume V of the asset with the first volume V1, the weight W of the asset with the first weight W1, respectively:

When V>V1, select a large volume area as the deposit area of the asset;

When W≥W1, select a large weight area as the deposit area of the asset;

When V<V1, W<W1, calculate a weight state value S of the asset according to the following formula, the formula is:

S=aV+bW;

compare the weight state value S of the asset with the z state preset values S1, S2, S3, . . . , Sz, respectively, and when S≥Sc, use the cth balanced area as the deposit area of the asset;

where, a and b are preset values, 1≤c≤z.

Preferably, the information matching module is specifically configured to:

obtain a volume V and a weight W of the asset in the qth deposit sub-area in the pth deposit area;

associate and store the volume V and the weight W of the above-mentioned asset with a numbering pq of the deposit sub-area;

associate and store the occupied state of the pqth deposit sub-area with the volume V and weight W of the asset in the qth deposit sub-area in the pth deposit area;

where, 1≤p≤M, 1≤q≤N.

Preferably, the intelligent regulation module is specifically configured to:

obtain a numbering ij of the deposit sub-area in the occupied state;

obtain the volume and weight of the asset in the ijth deposit sub-area based on the numbering ij of the deposit sub-area, denoted as Vij and Wij;

collecting the actual volume and actual weight of the asset in the ijth deposit sub-area, denoted as V0 and W0; compare V0 with Vij, W0 with Wij respectively:

When V₀<Vᵢⱼ, formulate a first asset management regulation strategy;

When W₀<Wᵢⱼ, formulate a second asset management regulation strategy;

When V₀<Vᵢⱼ, W₀<Wᵢⱼ, formulate a third asset management regulation strategy;

where, the first asset management regulation strategy is: sending information of a volume reduction of asset in the ijth deposit sub-area to a regulatory department;

the second asset management regulation strategy is: sending information of a weight reduction of asset in the ijth deposit sub-area to the regulatory department;

the third asset management regulation strategy is: sending information of the volume and weight reduction of the asset in the ijth deposit sub-area to the regulatory department.

The intelligent regulation system for asset management proposed by the present application, first selects a suitable deposit area according to the volume size and weight of the deposited asset, on the one hand, which can improve the deposit efficiency and effect of the assets , and on the other hand, which is convenient for the relevant personnel to quickly find the specific deposit location according to the actual volume and weight range of the target asset, simplifying the tracking and supervision of the assets for the above-mentioned personnel; then, further selects a smaller deposit sub-area according to the type and use of the asset in each deposit area, and deposits the assets of the same type and the same use in adjacent or similar positions, which not only optimizes the space occupancy of each deposit area, but also improves the deposit efficiency of each deposit area, providing a stable and effective reference basis for the asset management process.

The present application also provides a dedicated deposit space for large-volume assets and large-weight assets while selecting deposit areas for different assets, balancing the dynamic demand between the volume and weight of the assets and the deposit space, and ensuring the deposit effect of the assets. When depositing assets that are balanced in volume and weight, the present application further calculates the weight state of the asset by weighting its volume and weight, and then selects a suitable deposit sub-area according to the weight state, thereby further optimizing the selection process of the deposit sub-area and the deposit efficiency, providing a simple and quick reference basis for later asset inspection; finally, the application determines whether the assets in the deposit sub-area have been exchanged or lost according to the actual volume and actual weight of each asset in the deposit sub-area, and sends an early warning information to a superior regulatory department according to different levels of abnormal conditions, so that the regulatory department can quickly and accurately understand the actual situation and adopt a targeted adjustment plan in time, to realize the intelligent monitoring of the asset and optimize the order of asset management, improving the efficiency of asset management.

### BRIEF DESCRIPTION OF DRAWING

FIG. 1 is a schematic structural diagram of an intelligent regulation system for asset management.

### DETAILED DESCRIPTION OF THE INVENTION

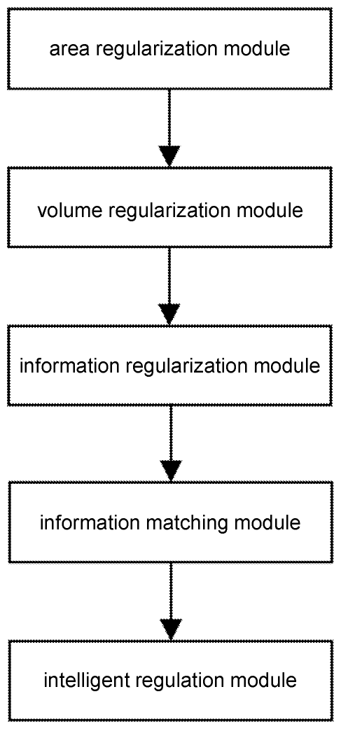

As shown in FIG. 1, FIG. 1 is a schematic structural diagram of an intelligent regulation system for asset management.

Refer to FIG. 1, the intelligent regulation system for asset management proposed by the application includes:

an area regularization module, configured to divide a target space into M deposit areas, and respectively divide each deposit area into N deposit sub-areas.

In the present embodiment, the M deposit areas include x large volume areas, y large weight areas, and z balanced areas;

the M deposit areas are divided according to the volume and weight of the assets to be deposited, so that the M deposit areas can fully satisfy the deposit space requirements of assets of different volume and weights, which is beneficial to improving the deposit efficiency and effect of the assets;

where x, y, and z are preset values, x+y+z=M, 1≤x<M, 1≤y<M, 1≤z<M.

Volume regularization module, configured to obtain the volume and weight of an asset, and select a deposit area according to the volume and weight of the asset;

in the present embodiment, a first volume V1, a first weight W1, and z state preset values are stored in the volume regularization module, which are denoted as S₁, S₂, S₃, . . . , S_{z}, where S₁<S₂<S₃< . . . <S_{z};

the volume regularization module is specifically configured to:

obtain the volume and weight of the asset, respectively denoted as V and W;

compare the volume V of the asset with the first volume V1, the weight W of the asset with the first weight W1, respectively:

when V≥V1, it indicates that the actual volume of the asset to be deposited is large, then select a large volume area as the deposit area of the asset to improve the deposit effect of the asset;

when W≥W1, it indicates that the actual weight of the asset to be deposited is large, then select a large weight area as the deposit area of the asset, on the one hand, to ensure the security of deposit, on the other hand, to improve the deposit efficiency of the deposit area;

when V<V1, W<W1, it indicates that the volume and weight of the asset to be deposited are within a moderate range, then calculate the weight state value S of the asset according to the following formula, to select a specific deposit location for the actual range of its volume and weight, the formula is:

S=aV+bW;

compare the weight state value S of the asset with the z state preset values S1, S2, S3, . . . , Sz, respectively, and when S≥Sc, it indicates that the weight status of the asset has reached the cth range, use the cth balanced area as the deposit area of the asset;

calculate the weight status by weighting the volume and weight of the asset separately, and then select the deposit area according to the actual value of the weight state, thereby achieving double dynamic balance between volume, weight and deposit area, further improving the deposit effect of the asset and deposit efficiency of the deposit space;

where, a and b are preset values, 1≤c≤z.

The information regularization module, configured to obtain the type and use of the asset in the deposit area, and select the deposit sub-area according to the type and use of the asset;

the information matching module, configured to associate and store the volume and weight of the asset as the identification information with the numbering of the asset deposit sub-area, and associate and store the occupied status of the M×N deposit sub-areas with the identification information of the asset.

In the embodiment, the information matching module is specifically configured to:

obtain a volume V and a weight W of the asset in the qth deposit sub-area in the pth deposit area; associate and store the volume V and the weight W of the above-mentioned asset with the numbering pq of the deposit sub-area;

associate and store the occupied state of the pqth deposit sub-area with the volume V and weight W of the asset in the qth deposit sub-area in the pth deposit area; where, 1≤p≤M, 1≤q≤N.

Intelligent regulation module, configured to formulate an asset management regulation strategy based on the occupancy status of the ijth deposit sub-area, the identification information of the asset in the ijth deposit sub-area, and the actual volume and actual weight of the asset in the deposit sub-area;

where, M and N are preset values, M≥3, N≥3, 1≤i≤M, 1≤j≤N.

In the present embodiment, the intelligent regulation module is specifically configured to:

obtain the numbering ij of the deposit sub-area in the occupied state;

obtain the volume and weight of the asset in the ijth deposit sub-area based on the numbering ij of the deposit sub-area, denoted as Vij and Wij;

collecting the actual volume and actual weight of the asset in the ijth deposit sub-area, denoted as V0 and W0;

compare V0 with Vij, W0 with Wij respectively:

When V₀<Vᵢⱼ, it indicates that the actual volume of the asset in the ijth deposit sub-area is less than the original volume of the asset, then formulate a first asset management regulation strategy, to make the superior regulatory department understand the abnormal situation;

the first asset management regulation strategy is: sending information of the volume reduction of asset in the ijth deposit sub-area to the regulatory department; notifying the regulatory department to verify the actual state of the assets in the deposit sub-area in time to ensure the security of the deposit of the asset;

when W₀<Wᵢⱼ, it indicates that the actual weight of the asset in the ijth deposit sub-area is less than the original weight of the asset, then formulate a second asset management regulation strategy;

the second asset management regulation strategy is: sending information of the weight reduction of asset in the ijth deposit sub-area to the regulatory department; enabling the superior regulatory department to take timely response to the above information;

when V₀<Vᵢⱼ, W₀<Wᵢⱼ, W₀<Wᵢⱼ, it indicates that the actual volume and actual weight of the asset in the ijth deposit sub-area are less than the original volume and original weight of the asset, then formulate a third asset management regulation strategy to make the superior regulatory department understand the abnormal situation; the third asset management regulation strategy is: sending information of the volume and weight reduction of the asset in the ijth deposit sub-area to the regulatory department, facilitating the regulatory department to track the destination of the assets in the deposit sub-area in time to achieve priority monitoring of the assets.

The intelligent regulation system for asset management proposed by the present application, first selects a suitable deposit area according to the volume and weight of the deposited asset, on the one hand, which can improve the deposit efficiency and effect of the assets , and on the other hand, which is convenient for the relevant personnel to quickly find the specific deposit location according to the actual volume and weight range of the target asset, simplifying the tracking and supervision of the assets for the above-mentioned personnel; then, further selects a smaller deposit sub-area according to the type and use of the asset in each deposit area, and deposits the assets of the same type and the same use in adjacent or similar positions, which not only optimizes the space occupancy of each deposit area, but also improves the deposit efficiency of each deposit area, providing a stable and effective reference basis for the asset management process.

The disclosure also provides a dedicated deposit space for large-volume assets and large-weight assets while selecting deposit areas for different assets, balancing the dynamic demand between the volume and weight of the assets and the deposit space, and ensuring an effective deposit of the assets; when depositing assets that are balanced in volume and weight, the present application further calculates the weight state of the asset by weighting its volume and weight, and then selects a suitable deposit sub-area according to the weight state, thereby further optimizing the selection process of the deposit sub-area and the deposit efficiency, providing a simple and quick reference basis for the later asset inspection; finally, the application determines whether the assets in the deposit sub-area have been exchanged or lost according to the actual volume and actual weight of each asset in the deposit sub-area, and sends an early warning information to the superior regulatory department according to the different levels of abnormal conditions, so that the regulatory department can quickly and accurately understand the actual situation and adopt a targeted adjustment plan in time, to realize the intelligent monitoring of the assets and optimize the order of asset management, improving the efficiency of asset management.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

1. An intelligent regulation system for asset management, comprising:
an area regularization module, configured to divide a target space into M deposit areas, and respectively divide each deposit area into N deposit sub-areas;
a volume regularization module, configured to obtain volume and weight of an asset, and select a deposit area according to the volume and weight of the asset;
an information regularization module, configured to obtain a type and use of the asset in the deposit area, and select the deposit sub-area according to the type and use of the asset;
an information matching module, configured to associate and store the volume and weight of the asset as identification information with a numbering of the asset deposit sub-area, and associating and storing occupied status of M×N deposit sub-areas with the identification information of the asset;
an intelligent regulation module, configured to formulate an asset management regulation strategy based on the occupied status of the ijth deposit sub-area, the identification information of the asset in the ijth deposit sub-area, and the actual volume and actual weight of the asset in the deposit sub-area;
wherein, M and N are preset values, M≥3, N≥3, 1≤i≤M, 1≤j≤N.

2. The intelligent regulation system for asset management according to claim 1, wherein, in the area regularization module, the M deposit areas comprise x large volume areas, y large weight areas, and z balanced areas;
wherein x, y, and z are preset values, x+y+z=M, 1≤x<M, 1≤y<M, 1≤z<M.

3. The intelligent regulation system for asset management according to claim 2, wherein, a first volume V1, a first weight W1, and z state preset values are stored in the volume regularization module, which are denoted as S1, S2, S3 . . . Sz, wherein S1<S2<S3< . . . <Sz;
the volume regularization module is specifically configured to:
obtain the volume and weight of the asset, respectively denoted as V and W;
compare the volume V of the asset with the first volume V1, the weight W of the asset with the first weight W1, respectively:
when V≥V1, select a large volume area as the deposit area of the asset;
when W≥W1, select a large weight area as the deposit area of the asset;
when V<V1, W<W1, calculate a weight state value S of the asset according to the following formula, the formula is:
S=aV+bW;
compare the weight state value S of the asset with the z state preset values S1, S2, S3, . . . , Sz, respectively, and when S≥Sc, use the cth balanced area as the deposit area of the asset;
wherein, a and b are preset values, 1≤c≤z.

4. The intelligent regulation system for asset management according to claim 3, wherein, the information matching module is specifically configured to:
obtain a volume V and a weight W of the asset in the qth deposit sub-area in the pth deposit area;
associate and store the volume V and the weight W of the above-mentioned asset with a numbering pq of the deposit sub-area in which the asset are deposited;
associate and store an occupied state of the pqth deposit sub-area with the volume V and weight W of the asset in the qth deposit sub-area in the pth deposit area;
wherein, 1≤p≤M, 1≤q≤N.

5. The intelligent regulation system for asset management according to claim 4, wherein, the intelligent regulation module is specifically configured to:
obtain the numbering ij of the deposit sub-area in the occupied state;
obtain the volume and weight of the asset in the ijth deposit sub-area based on the numbering ij of the deposit sub-area, denoted as Vij and Wij;
collect the actual volume and actual weight of the asset in the ijth deposit sub-area, denoted as V0 and W0;
compare V0 with Vij, W0 with Wij respectively:
when V0<Vij, formulate a first asset management regulation strategy;
when W0<Wij, formulate a second asset management regulation strategy;
when V0<Vij, W0<Wij, formulate a third asset management regulation strategy;
wherein, the first asset management regulation strategy is: sending information of volume reduction of the asset in the ijth deposit sub-area to a regulatory department;
the second asset management regulation strategy is: sending information of weight reduction of the asset in the ijth deposit sub-area to the regulatory department;
the third asset management regulation strategy is: sending information of the volume and weight reduction of the asset in the ijth deposit sub-area to the regulatory department.
